(19) United States
(12) Patent Application Publication
(10) Pub. No.: US 2021/0153514 A1
(43) Pub. Date: May 27, 2021

(54) SPIRAL-PUMP FOR TREATING FOOD ITEMS

(71) Applicant: Skaginn HF., Akranes (IS)

(72) Inventor: Ingolfur ARNASON, Akranes (IS)

(21) Appl. No.: 17/259,144

(22) PCT Filed: Jul. 10, 2019
(86) PCT No.: PCT/IS2019/050006

§ 371 Date: Jan. 8, 2021

(30) Foreign Application Priority Data
Jul. 10, 2018 (IS) 050229
May 6, 2019 (IS) 050267

(51) Int. Cl. A23B 4/06; A22C 25/02; A22C 21/00; A23B 4/16; A23L 3/36; A23L 3/3409; A23L 3/00

(52) U.S. Cl. CPC A23B 4/062; A22C 25/02; A22C 21/0061; A23B 4/16; A23V 2002/00; A23L 3/3409; A23L 3/001; A23L 3/003; A23L 3/361

(57) ABSTRACT

The present invention relates to a method and a device for treating and/or transporting food items. The apparatus and method are designed to facilitate treating food items in liquid. The device of the present invention is designed as a spiral pump with a tubing that is wound around a frame structure which rotates around a horizontal axis. The apparatus of the present invention and the use thereof provides a method to treat food items in a spiral pump, where the food items are treated cycle by cycle in the pump.

### FIELD OF THE INVENTION

The invention relates to a method and a device for treating, rinsing, cooling and adding substances to food items. Such method and device may, for instance, be used to cool down and add anti-bacterial substances to food items during the cooling process.

### BACKGROUND

A continuous development of food processing, such as processing of fish products is always on demand with the focus on for instance to increase utilization and value of products as well as meeting demands for quality after processing. Cooling, rinsing, bleeding of freshly slaughtered animals such as fish, poultry requires mechanic devices to facilitate fast, efficient but relatively gentle handling and transportation through these processes.

One of the parts of the processing fish is the bleeding step. In a processing line where speed is of essence, one of the problems is that after the fish is bleed and gutted the fish will bleed into the meat. This will have an effect on the colour of the meat and thereby the price which can be obtained for the final product. Another problem is waste management of biological material such as blood, which is costly and leaves environmental footprints.

One of the problems in the food industry is getting rid of bacteria such as Listeria in Salmon and Salmonella in chicken. For Listeria, the solution has been to freeze the salmon to get rid of this bacteria. This however poses a problem for delivery of fresh salmon for the market.

There are several different types of devices known in the art for cooling, rinsing, bleeding food items and adding substances to food. Means such as screw conveyors in tanks are known as well as cleated/separated transport conveyor belts passing through a tub have been used for the purpose of bleeding and rinsing and passing food items in and out of a solution with additives to treat food items with anti-bacterial agents or adding phosphate has been done in tubs with sea water, brine, water or fluid ice.

Spiral pumps have been used to transport items delicately through a closed environment in a low pressure system. Such pumps are ideal for pumping water-mixed material such as raw and cooked shrimp, shellfish and pelagic and other small fish according to the principle of Archimedes. By rotating slowly, the pump facilitates transport and/or elevation of water and material through pipes, without using any propeller. The food items are gently conveyed in a closed environment. The system also prevents the items from being exposed to the outside environment.

U.S. Pat. No. 3,586,510 discloses an apparatus for conveying a material from a zone at atmospheric pressure to a zone at a different pressure and then back to the zone at atmospheric pressure. The apparatus is a helical would pump and rotating about an axis. The food items are fed in at an in-feed end in liquid in the form of separate slugs equal to the volume of a half turn of the tube, where the slugs alternate with equal volumes of air. The inlet and outlet are at atmospheric pressure, whereas the centre zone for treatment of the food items is at a positive or negative pressure. The coils of the centre zone have cross-connections to equalise the pressure, which is arranged by small air feedback tubes on the outside of coil being connected from the windings downstream of the centre zone to the upstream windings.

### SUMMARY OF THE INVENTION

The present invention provides a method and a device for treating, processing and/or transporting food items. The apparatus and method are designed to facilitate treating food items in liquid. The device of the present invention is designed as a spiral pump with a tubing that is wound around a frame structure which rotates around a horizontal axis. The apparatus of the present invention and the use thereof provides a method to treat food items in a spiral pump, where the food items are treated cycle by cycle in the pump at various speed in each cycle and or with a rocking movement of the pump, where the tubing is wound around the frame of the pump or with other shape to increase movement of the food items in the pump. The new method and apparatus can further be provided with a new in-feeding mechanism and sensors, where under-pressure is created in the first winding to suck the food items into the first winding during a time period when the in-feed end of the tubing is opened by the in-feeding device. The new method is performed by introducing a calculated amount of liquid and food items into the first winding of the spiral pump and then rotating the tubing only one cycle at the time to move the food items in the liquid into the second winding before introducing adding new portion of food items and liquid. The principle of Archimedes ensures that if the total amount of liquid, food items and additives does not exceed 50% of the volume of a winding the food items in the winding do not mix with the food items in the next winding and the air filling about 50% or more of the volume of the winding pushes the content of a prior winding to the next one. The method and device of the present invention uses a spiral pump to cool down and rinse food items or even to facilitate bleeding of newly slaughtered animals, such as fish or chicken. The rocking movement allows the fluid to flow alongside the product, thus achieving improved efficiency in one or more of cooling, heating, bleeding, soaking or bacterial treatment as well as or resulting in achieving any special condition in the food items which may improve processing such as skinning, filleting or removal of pin bones in fish such as salmon. Therefore, the fluid flow has the same effect as wind-cooling and faster because of all cooling and heating functions. This may be referred to as flow-chilling

The device and method of the present invention is further suitable for rinsing sensitive food items such as fish liver without rupturing or damaging the sensitive food items. It is a further advantage of the device of the present invention that it allows the use of ozone for anti-bacterial treatment of food objects as it comprises a closed system for the ozone. The ozone is pumped into a selected winding of the spiral pump, such that the air/gas phase can only be advanced forward in the pump but is now able to flow out of the in-feed opening of the pump. By using feeding pipes connected to the tubing of the pump, air/gas or liquid into a selected winding of the pump and in the same manner to extract air/gas or liquid from a selected winding of the pump.

It is an object of the present invention to overcome and/or ameliorate the aforementioned drawbacks of the prior art and to provide an improved and/or alternative and/or additional method or device for facilitating processing or treatment food items in liquid by using a spiral pump. It is one preferred object of the present invention to provide a method and device to facilitate treatment of food using the spiral pump of the present invention. Moreover, it is a preferred object of the present invention to provide a method and device, preferably designed to rinse food items, bleed fish and optionally collect blood from fish, as well as to cool down food items while being transported or conveyed from one location to another. Another preferred object of the present invention is to provide a device having a design where food items are collected in an in-feeding chamber before a batch of food items with liquid or fluid ice to make up a blend before they are introduced into a first winding of a spiral pump and rotating the pump in intervals about 360° with stops for adding another batch of food items in liquid and additives to the first winding and for adding. An important aspect of the present invention is batch treatment and a portioning of food items by rotating the windings of the pump one round at the time thereby controlling the time of treatment and also controlling the amount if food items vs liquid and additives based on the nature of the food items.

The object(s) underlying the present invention is (are) particularly solved by the features defined in the independent claims. The dependent claims relate to preferred embodiments of the present invention. Further additional and/or alternative aspects are discussed below.

Thus, at least one of the preferred objects of the present invention is solved by an apparatus for treating food items in liquid media, the apparatus comprising a) a tubing with an in-feed end and an out-feed end and where the tubing having three or more windings. The apparatus further comprises a horizontally rotating frame structure, wherein the tubing is wound around and/or into the frame structure, a motor, and control means, wherein the control means controls the motor and the motor rotates the horizontally rotating frame structure. Furthermore, the control means alters the speed of the rotation of the horizontally rotating frame structure at least once during every full cycle (360°) rotation.

Another preferred object of the present invention is solved by a method for treating food items, the method comprising:
a) providing a spiral pump, said spiral pump further comprising
   a tubing with an in-feed end and an out-feed end, said tubing having three or more windings,
   a horizontally rotating frame structure, wherein the tubing is wound around and/or into the frame structure,
   a motor, and
   control means,
b) feeding liquid through the in feed end into the first winding of the tubing wound around the frame structure,
c) feeding one or more food items into the first winding of the tubing wound around the frame structure through the in-feed end,
d) rotating the frame structure a full cycle around a horizontal central axis, e) repeating steps b)-d) while there are food items to be feed into the first winding of the tubing wound around the frame structure, and
f) when the last items have undergone steps b)-e), the frame structure is rotated until the last food items have exited the out-feed end of the tubing.

The method is characterised in that the motor rotates the horizontally rotating frame structure where the control means alters the speed of the rotation at least once during every full cycle (360°) rotation.

One of the preferred objects of the present invention is solved by an apparatus for treating food items in liquid media, the apparatus comprising a) a tubing with an in-feed end and an out-feed end and where the tubing having three or more windings. The apparatus further comprises a horizontally rotating frame structure, wherein the tubing is wound around and/or into the frame structure, a motor, and control means, wherein the control means controls the motor and the motor rotates the horizontally rotating frame structure. Furthermore, the apparatus further comprises an in-feeding device for feeding food items into the in-feed end of the tubing, said in-feeding device further comprising an in-feed chamber, and a closing means between the in-feed chamber and the in-feed end of the tubing. Such a device may further comprise an air-inlet in the first winding for creating under-pressure in the first winding of the pump.

Another preferred object of the present invention is solved by a method for treating food items in liquid media or air/gas. The method comprises the steps of:
a) providing a spiral pump, said spiral pump further comprising
   a tubing with an in-feed end and an out-feed end, said tubing having three or more windings,
   a horizontally rotating frame structure, wherein the tubing is wound around and/or into the frame structure,
   a motor, and
   control means,
b) feeding liquid through the in feed end into the first winding of the tubing wound around the frame structure,
c) feeding one or more food items into the first winding of the tubing wound around the frame structure through the in-feed end,
d) rotating the frame structure a full cycle around a horizontal central axis,
e) repeating steps b)-d) while there are food items to be feed into the first winding of the tubing wound around the frame structure, and
f) when the last items have undergone steps b)-e), the frame structure is rotated until the last food items have exited the out-feed end of the tubing.

The method is characterised in that the food items are fed into the in-feed end of the tubing from an in-feeding device, wherein the in-feeding device further comprises an in-feed chamber and closing means between the in-feed chamber and the in-feed end of the tubing. A further aspect of this object is that the spiral pump may further comprise an air-inlet in the first winding for creating under-pressure in the first winding of the pump.

Another preferred object of the present invention is solved by an apparatus for treating food items in liquid media, the apparatus comprising a) a tubing with an in-feed end and an out-feed end and where the tubing having three or more windings. The apparatus further comprises a horizontally rotating frame structure, wherein the tubing is wound around and/or into the frame structure, a motor, and control means, wherein the control means controls the motor and the motor rotates the horizontally rotating frame structure. Furthermore, one or more of the windings in the pump is a semi-circular winding around the frame structure.

Furthermore, one of the preferred objects of the present invention is solved by an apparatus for treating food items in liquid media, the apparatus comprising a) a tubing with an in-feed end and an out-feed end and where the tubing having three or more windings. The apparatus further comprises a horizontally rotating frame structure, wherein the tubing is wound around and/or into the frame structure, a motor, and control means, wherein the control means controls the motor and the motor rotates the horizontally rotating frame structure. Furthermore, the apparatus further comprises one or more feeding pipes for introducing or extracting liquid or air from the tubing.

Another preferred object of the present invention is solved by a method for treating food items in liquid media or air/gas. The method comprises the steps of:
a) providing a spiral pump, said spiral pump further comprising:
   a tubing with an in-feed end and an out-feed end, said tubing having three or more windings,
   a horizontally rotating frame structure, wherein the tubing is wound around and/or into the frame structure,
   a motor, and
   control means,
b) feeding liquid through the in feed end into the first winding of the tubing wound around the frame structure,
c) feeding one or more food items into the first winding of the tubing wound around the frame structure through the in-feed end,
d) rotating the frame structure a full cycle around a horizontal central axis,
e) repeating steps b)-d) while there are food items to be feed into the first winding of the tubing wound around the frame structure, and
f) when the last items have undergone steps b)-e), the frame structure is rotated until the last food items have exited the out-feed end of the tubing.

The method is characterised in that liquid or air can be fed into or extracted from one or more of the windings of the pump using one or more feeding pipes.

The present invention further provides an apparatus and method to facilitate bleeding and rinsing of whole slaughtered fish before processing or cooling, where collection of at least portion of the blood is possible during rinsing the fish with water or other liquid. One of the challenges in modern food industry is to reduce the amount of water used in producing food as well as using as much of the animals slaughtered for production of food. This includes exploring use of parts of the animals not used before and managing waste material in an environmental manner. Blood from fish during slaughtering has traditionally been rinsed off the fish using water or sea water, which then has to be disposed of with costly methods. The present invention provides a device and method to reduce waste and waste management of biologic material as well as rinsing and concentrating blood from freshly caught and slaughtered fish. The blood can then be collected and use for various purposes to increase the economic value of the fish. Therefore another preferred object of the present invention is solved by a method to facilitate bleeding of fish, the method comprises the steps of:
a) providing a spiral pump comprising a tubing with an in-feed end and an out-feed end, where the tubing has three or more windings. The pump further comprises a horizontally rotating frame structure, where the tubing is wound around and/or into the frame structure. The pump also comprises a motor and control means, where the control means controls the motor and the motor rotates the horizontally rotating frame structure,
b) feeding liquid through the in feed end into the first winding of the tubing wound around the frame structure,
c) feeding one or more food items into the first winding of the tubing wound around the frame structure through the in-feed end,
d) rotating the frame structure a full cycle around a horizontal central axis,
e) repeating steps b)-d) while there are food items to be feed into the first winding of the tubing wound around the frame structure, and
f) when the last items have undergone steps b)-e), the frame structure is rotated until the last food items have exited the out-feed end of the tubing.

The motor rotates the horizontally rotating frame structure where the control means alters the speed of the rotation at least once during every full cycle (360°) rotation. Furthermore, the blood from the tubing is collected and stored or redirected into the first or second winding of the tubing for continued rinsing and bleeding. All embodiments listed herein relate to both the apparatus, system and the method of the present invention.

In the present context the following applies to the position of the pump and the orientation of rotation: i) when the in-feed tube, being the first potion of the tub leading to the frame for rotating around the frame, is pointing down (−90° in the standard coordinate system of 360°) it is defined as 0° herein, ii) a clockwise rotation is defined by “+” and counter clockwise rotation is defined by “-”.

In the present context the terms “full cycle” and “cycle of rotation” refers to a 360° rotation of the frame structure and the tubing wound around the frame structure. The rotation of the frame structure may be stopped at any position of each full cycle for feeding a blend into the tubing, but the rotation can also be continuous.

In the present context the terms “rocking movement” or “rocking motion” relates to rotating the pump, or the frame with the pump arranged along the frame, back and forth the same amount of degrees repeatedly. The rocking movement performed for a pre-determined number of times and/or for a pre-determined period (e.g. seconds) based on what food items are being process and what kind of processing the food items are being subjected to. The rocking motion in the tubing is operated by the control means where the motor rotates the horizontally rotating frame structure backwards and forwards repeatedly for a predetermined period.

In the present context the terms “treating food items”, “treating food items in liquid media” and “processing or treating food items in liquid” relate to rinsing, washing, bleeding, cooling or adding substances to food items such as, but not limited to, salts, phosphates or anti-bacterial agents etc.

In the present context the terms “food items” or “food objects” are used equally for food items such as slaughtered fish or chicken, as well as for parts or animals such as aquatic animals, birds or other smaller slaughtered animals.

In the present context the term “under-cooling” or “sub-chilling” refers to the process or method of bringing fish to a desired temperature at or near the phase transition of freezing the fish without freezing the fish, and generally below the freezing point of water (0° C.). Furthermore, these terms refer to a fish or fish product being brought to or kept at a desired temperature at or near the phase transition of freezing the fish without freezing the fish, such as a temperature below 0° C. (sub-zero conditions), such as preferably at or below −0.2° C., or more preferably at or below −0.5° C., or at or below −0.7° C., or at or below −0.8° C., such as at or below −1.0° C., such as at or below −1.5° C.

In an embodiment of the present invention the liquid and the one or more food items are pre-blended before feeding into the first winding of the tubing wound around the frame structure thereby performing steps b) and c) simultaneously. This is generally referred to as “the blend”.

In an embodiment of the present invention the control means generates a rocking motion in the tubing by rotating the horizontally rotating frame structure alternately backwards and forwards repeatedly for a predetermined period.

In an embodiment of the present invention the apparatus further comprises an in-feeding device for feeding food items into the in-feed end of the tubing, where the in-feeding device further comprises an in-feed chamber, and a closing means between the in-feed chamber and the in-feed end of the tubing.

In an embodiment of the present invention the apparatus further comprises an air-inlet in the first winding for creating under-pressure in the first winding of the pump.

In an embodiment of the present invention the apparatus further comprises a sensor for determining the position of the windings of the pump in each cycle of rotation.

In an embodiment of the present invention one or more of the windings in the pump is a semi-circular winding around the frame structure.

In an embodiment of the present invention the one or more semi-circular winding around the frame structure has pentagonal, hexagonal, heptagonal, octagonal, nonagonal, decagonal shape or where a circular winding has one or more ridges or indents in the circular shape.

In an embodiment of the present invention the apparatus further comprises one or more feeding pipes for introducing or extracting liquid or air from the tubing. In further embodiments, the feeding pipe for introducing or extracting liquid or air from the tubing comprises a centrally arranged first feeding pipe in the frame structure and on or more second feeding pipes feeding into the tubing from first feeding pipe.

In an embodiment of the present invention the apparatus has two or more sets of first and second feeding pipes in the frame structure introducing or extracting liquid and air from the tubing or more than one type of air or liquid into the tubing

In an embodiment of the present invention the feeding pipe for introducing or extracting liquid or air/gas from the tubing comprises a centrally arranged first feeding pipe in the frame structure and on or more second feeding pipes feeding into the tubing from first feeding pipe.

In an embodiment of the present invention the apparatus has two or more sets of first and second feeding pipes in the frame structure introducing or extracting liquid and air from the tubing or more than one type of air or liquid into the tubing.

In an embodiment of the present invention under-pressure is created in the first winding of the pump through an air-inlet in the first winding.

In an embodiment of the present invention a sensor determines the position of the windings of the pump in the cycle of rotation.

In an embodiment of the present invention a sensor detects when the first winding is approaching in-feeding position in its cycle of rotation. In this embodiment the detection of the pump approaching in-feeding position may initiate an opening from the in-feed chamber into the first winding of the pump.

In an embodiment of the present invention more than one type of air and/or liquid is introduced or extracted into or from one or more of the windings of the pump by using two or more sets of first and second feeding pipes in the frame structure.

In an embodiment of the present invention the food items are subjected to one or more steps of sub-chilling or under-cooling along with other treatment of the food items as they are transported through the pump by feeding a salt-controlled and temperature controlled solution into the tubing of the spiral pump.

In an embodiment of the present invention the pressure in each winding or a number of windings can be changed by introducing or removing air from one or more windings of the pump.

In a specific embodiment the of the present invention under-pressure is created in the first part of the pump (2-3 windings), then an over-pressure is created in the next few windings (windings 4-6) and overpressure is released in the remaining windings (windings 7-10).

In an embodiment of the present invention the pressure in each winding or a number of windings is changed by introducing or removing air from one or more windings of the pump during the rocking movement. This can be done when the pump is in a 180° position.

In an embodiment of the present invention two or more pumps are serially connected to provide separate treatment in separate pumps. In such an embodiment the first pump can provide treatment for a certain time period with liquid at a predetermined temperature (for example at 60° C. for 15 sec). The blend is then discharged from the pump and the liquid separated from the food items. The items are mixed with new chilled liquid or even fluid ice (for example at −10° C. in for 30 sec). The treatment in the first pump heats the surface before rapid cooling in the second pump, which facilitates reduction or elimination of bacteria, may provide improved bleeding and speed of bleeding and increase efficiency of further processing of food items such as fish. Furthermore, better control of in-feeding, speed of rotation and location of the tubing of the pump at all times enhances the advantages of serial connection of pumps and synchronising their operation.

In an embodiment of the present invention food items are subjected to bacterial treatment by rapid treatment in one or more windings at a temperature such as 60° C. and then subsequently subjecting the same food items to rapid cooling at a temperature such −20° C.

In an embodiment of the present invention food items are subjected to loosening membranes from the food items or skin from animals or animal parts by rapid treatment in one or more windings at a temperature such as 60° C. and then subsequently subjecting the same food items to rapid cooling at a temperature such −4° C.

In an embodiment of the present invention the out-feed end of the pipe is formed into channels or semi-channels to distribute the food items laterally as the food items are fed out of the apparatus.

In one aspect a method is provided using one or more pumps of the invention to loosen skin and membranes from the fish before processing, where slaughtered fish is sub-chilled to a homogenous temperature at between −0,1 to −2° C. Subsequently the fish is subjected to a higher temperature, such as between 25-60° C. for a short period of time in one or more windings of the pump, such that only the surfaces (skin and abdomen) is heated. This will result in the in increased (expanded) surface volume of membranes and skin as compared to the flesh/meat. Next the fish is subjected to cooling in one or more windings of the pump or a subsequent pump at a temperature below the temperature of the flesh. This results in shrinking of membranes and skin as they freeze.

In some embodiments the device and method of the present invention is used for rinsing sensitive food items such as fish liver without rupturing or damaging the sensitive food items.

In an embodiment of the present invention ozone is used for anti-bacterial treatment of food objects as the pump comprises a closed system for the ozone. The ozone is pumped into a selected winding of the spiral pump, such that the air/gas phase can only be advanced forward in the pump but is now able to flow out of the in-feed opening of the pump. By using feeding pipes connected to the tubing of the pump, air/gas or liquid into a selected winding of the pump and in the same manner to extract air/gas or liquid from a selected winding of the pump.

In an embodiment of the present invention the spiral pump is used for batch treatment of food items, where a batch is fed into the first winding of the pump and as that batch is ejected out of the pump the batch is collected for further processing or packing without blending with food items from earlier or later batches. One Example of a pump of the present invention is disclosed here below where the pump is controlled to rotate with alternating speed in each cycle and the in-feeding device uses under-pressure in the first winding to speed in-feeding into the pump:
A. Detector determines the orientation or position in rotation of the pump and when the pump is in a certain position the pump run cycle is initiated. Optionally, the orientation or position in rotation of the pump is determined mechanically and a signal from mechanic detection interacts with a computer and a motor for running the cycles of the pump.
B. The speed of the pump is adjustable for any part of the cycle. When the pump is used for treating or processing food items the treatment or process is determined by each cycle starting at a starting position (home position).
C. In this example the pump is rotated by a servo motor, which provides a perfect control of each step in a process cycle including speed, direction of rotation (rocking movement) at what position the pump stops and if a reverse rotation is required.
D. An in-feed chamber is positioned in front of the in-feed opening into the tubing of the pump. The in-feed chamber determines and equals around half of the volume of a winding in the pump.
E. In this embodiment, the food items and the liquid for the treatment is pre-blended to give a desired portion which is then feed into the pump. Optionally, the in-feeding needs to happen quickly to maintain good working speed of the pump. By creating under-pressure in the first winding of the pump the content/blend in the in-feeding chamber is sucked into the first winding when the lid separating the in-feeding chamber and the tubing of the pump is removed.
F. The liquid fed in with the food items can be chilled if desired and it can also be mixed with fluid ice in the in-feeding chamber to increase cooling efficiency of the pump.
G. Optionally, heated liquid can be mixed with the food items before feeding into the pump.
H. A lid or opening and closing device is positioned between the in-feeding chamber and the inlet into the tubing of the pump for controlling in-feeding into the pump.
I. Optionally an inlet from an air-pump is positioned after the lid or opening and closing device leading to the first winding of the pump which can pump the air in and out of the pump as desired. By pumping air into the pump simultaneously to the in-feeding of the blend of food items and liquid, a mechanical control of the amount of air injected into each winding is provided. This is advantageous if the pump is fed at high speed and when the lid is closed as soon as the blend has been fed into the pump.
J. Once the lid to the in-feeding chamber is closed, air can be drawn from the pump and thus under-presser is generated in the first winding before opening the lid again.
K. By having under-pressure in the first winding, the material in the in-feeding chamber is sucked into the first winding which provides faster in-feeding.

In an example of a cycle for the spiral pump of the present invention where under pressure is created in the first winding, the process for each rotation would be as follows:
1. A sensor is positioned closed to the in-feeding part of the pump.
2. When the sensor is detects a new in-feeding position, the pump is set to speed 1 (low speed).
3. Lid opens for inflow into a pump from the in-feeding chamber.
4. Due to under-pressure in the first winding of the pump, the pump sucks the blend into the pump and drains all the content from the in-feeding chamber.
5. While the blend is being fed into the pump, the pump may rotate at different speeds, stand still or be in a reverse cycle.
6. Thus, the pump may be in a rocking movement while the material and liquid enter the pump.
7. The pump can also run at different speeds during the in-feeding step.
8. As soon as the material is sucked in, air can be pumped, pump side of the closing device.
9. While the pump transfers the content from the first winding into the second winding, the lid closes the in-feed opening into the pump.
10. Then the pump is set to high speed.
11. A new blend of food items and liquid is prepared in the in-feeding chamber.
12. When the location sensor detects the starting position, a new process is started and under-pressure is created in the pump. Thereby, the pump is ready to suck in the next blend as soon as the lid to the in-feeding chamber is opened.

An example of use of the pump according to the method and device of the present invention is as follows.
1. A batch of items and liquid is feed into the in-feed chamber, this is referred to as a blend.
2. The tubing of the pump enters into infeed position at high speed. A sensor detects when the pump is at a certain position, such as, but not limited to 300°. At that time the lid (or opening and closing mechanism) of the out-feed end of the in-feed chamber is removed from the in-feed opening into the pump and the blend flows into the pump. At this time the pump is rotating at a slow speed.
3. The lid is closed as soon as the in-feed chamber is empty.
4. Then, directly after the lid has closed the out-feed end of the in-feed chamber, the next blend is created in the in-feed chamber.
5. After in-feeding the pump initiates the rocking movement. The “rocking movement” is then defined e.g. between 320° and 40°, so the pump now stops at 40° for a pre-set standby time. The pump then rotates to at rocking speed in—direction of 320° where the pump will stop for a pre-set standby time.
6. The start and slow-down or stopping rotation is performed softly/slowly, particularly for sensitive food items such as live or blue whiting.
7. The rocking movement allows the fluid to flow alongside the product, thus achieving improved efficiency in one or more of cooling, heating, bleeding, soaking or bacterial treatment as well as or resulting in achieving any special condition in the food items which may improve processing such as skinning, filleting or removal of pin bones in fish such as salmon. Therefore, the fluid flow has the same effect as wind-cooling and faster because of all cooling and heating functions.
8. When the rocking movement is completed, the pump is at 40° position and is a stop.
9. Now the pump's goes into releasing mode, i.e. transferring the content from one winding to another or to feed the content out the pump. The pump speed is increased to a specified releasing speed.
10. The mechanical movement of the pump is implement the such that it starts releasing material from the last winding at 80° and the last winding has been emptied at 180°.
11. When the pump has released the content/blend from the last winding, the speed is increased to maximum speed to a certain position, such as, but not limited to 300° and a new cycle is started.

### DESCRIPTION OF VARIOUS EMBODIMENTS

The present invention will become more fully understood from the detailed description given hereinafter and the accompanying drawings which are given by way of illustration only, and thus, are not limitative of the present invention, and wherein:

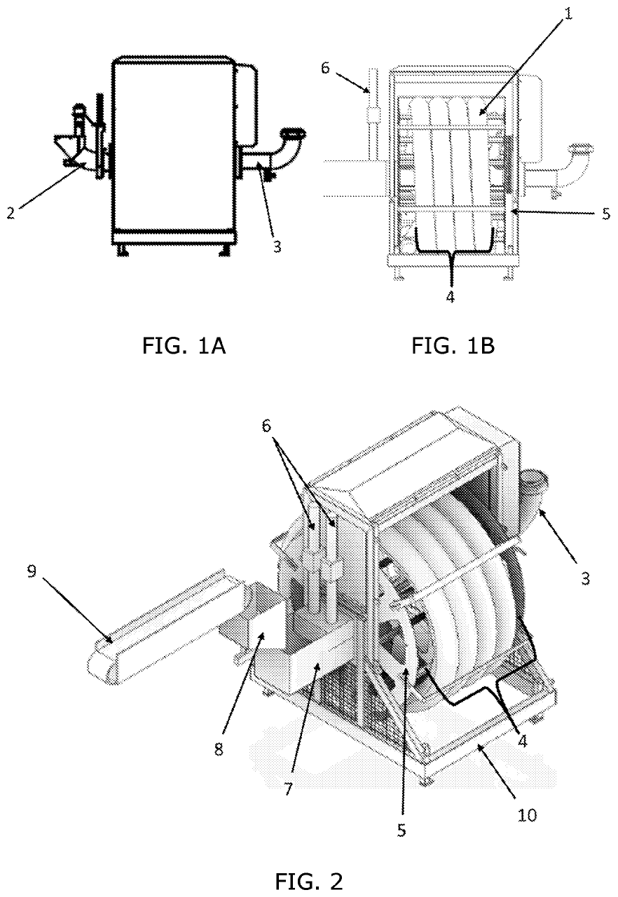

FIG. 1 is a front view of the apparatus of the present invention

FIG. 2 is perspective drawing of an apparatus according to one embodiment of the present invention.

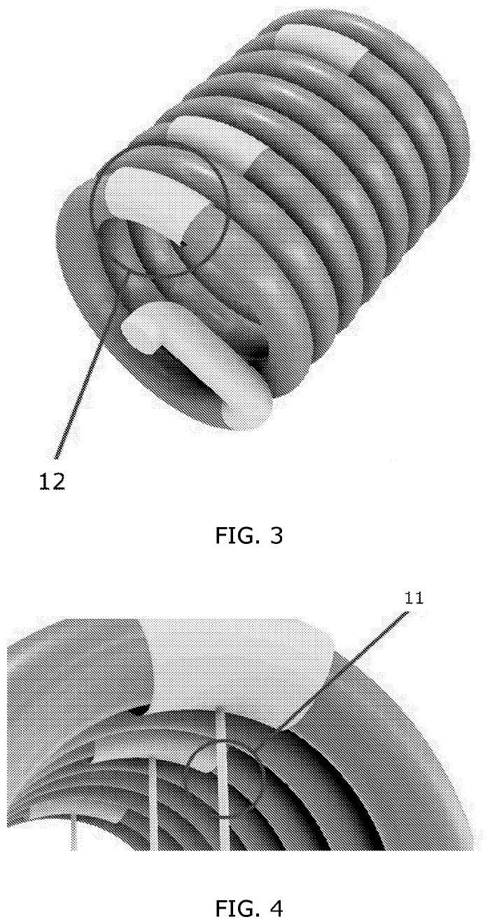

FIG. 3 is a transactional view showing a system for treating food items with an anti-bacterial agent.

FIG. 4 is a transection of the second winding a helical wound tubing with an air tubing.

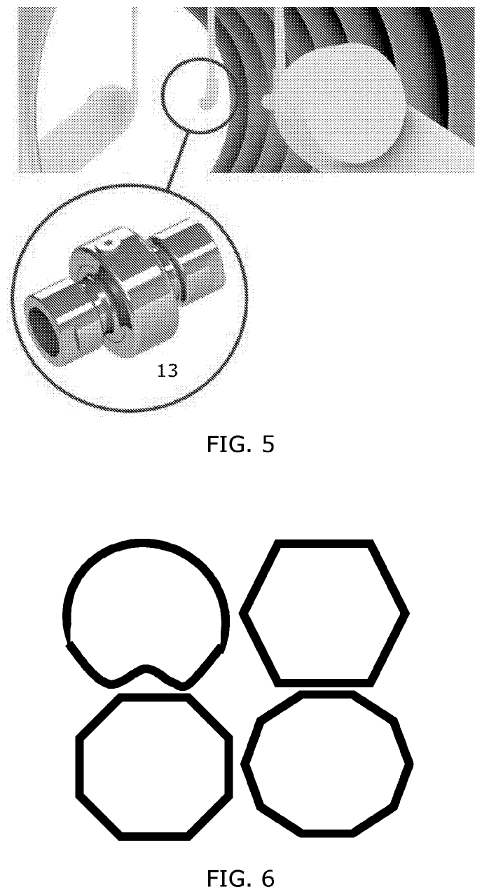

FIG. 5 shows an air/gas separating device for the spiral pump of the invention.

FIG. 6 shows alternative forms of one or more windings in the pump.

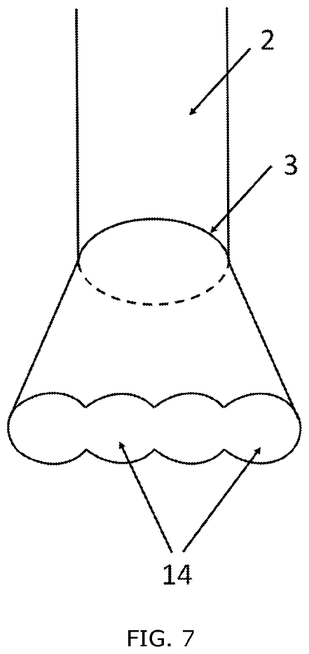

FIG. 7 shows an embodiment with a divider out-feed end of a spiral pump.

FIG. 1 shows the apparatus with (A) and without (B) a housing around the frame. The apparatus of the present invention is used for treating food items in liquid media such as sea water or liquid ice with or without salt and other additives. The apparatus comprises a helical wound tubing 1 with an in-feed end 2 and an out-feed end 3. In the embodiment shown in FIG. 1B the helical wound tubing has four windings 4 wound around and into a cylindrical frame structure 5 rotating around the horizontal central axis of the frame structure 5. At the in-feed end of the apparatus, there is a second tubing 6 shown for feeding liquid into the in-feed end of the helical wound tubing. The drawing also shows how the in-feed and the out-feed end of the helical wound tubing are centrally extending out of the cylindrical rotating frame structure.

FIG. 2 is a perspective view of the apparatus and an in-feeding mechanism according to one embodiment. The in-feeding end of the tubing is provided with an in-feeding chamber 7 for collecting items before feeding a batch of food items into the first winding of the pump. The in-feeding chamber 7 leads into the in-feed end of the tubing 1. Above the in-feeding chamber 7 a weighing chamber 8 is shown. The weighing chamber 8 comprises a scale for determining the weight of the food items prior to collecting them in the in-feeding chamber 7. Above the weighing chamber 8 an in feeding conveyor 9 is shown for feeding objects into the weighing chamber 8. Above the in-feed chamber 7 of the apparatus two inlet tubing 6 are shown feeding liquid, fluid ice and substances into the in-feed chamber 7 or the in-feed end of the helical wound tubing directly. The apparatus is shown standing on a support frame 10 supporting the rotating frame structure 5. The figure shows how the tubing is wound around and into a cylindrical frame structure 5 which rotates around a horizontal axis within the frame 5. The out-feed end 3 is shown as an upwardly extending tubing, but due to the nature of a spiral pump the material therein is pumped with a force which can easily deliver the content out of the pump to a level higher than the level of the pump. Although the in-feed end 2 and the out-feed end 3 of the helical wound tubing are centrally extending out of the cylindrical rotating frame structure a joint (not shown) in the centrally extending position of the tubing prevents any extension of the tubing from rotating. The amount of food items, liquid and additives is calculated such that it does not exceed 50% of the volume of each winding and preferably where the content of food items is around 40-45%. Then the frame structure 5 is rotated a whole cycle or approximately 360° around the horizontal axis. This brings the food items in the liquid or fluid ice and additives into the second winding. The steps of feeding liquid or fluid ice or brine, the food items and additives into the first winding and rotating the frame structure 5 is repeated as long as the pump is being operated or until the last content of the pump has been emptied out of the out-feed end of the pump. The time of treatment of food items is determined by the number of windings of the spiral pump and/or the amount of time between the rotations of the frame structure 5. Each of the tubing 6 for feeding liquid or fluid ice or brine and additives into the first winding of the tubing 1 either leads to the in-feeding chamber for mixing or into the first winding of the tubing 1.

FIG. 3 is a perspective view of eight windings 4 of a tubing 1 in a pump according to one embodiment of the invention where feeding pipes 11 are provided to introduce ore extract liquid or gas/air into one or more windings. A connecting cylinder 12 is placed around the tubing 1 to facilitate and support the connection of feeding pipes 11 into the tubing 1. In the embodiment shown in FIGS. 3-5 three connecting cylinders 12 are shown to ait the connection of three feeding pipes 11 to the first, the third and the seventh winding.

FIG. 4 shows a view of the connection of feeding pipes 11 to the connecting cylinders 12 according to the embodiment disclosed in FIG. 3.

FIG. 5 shows how the feeding pipes 11 extend to the centre of the void within the windings 4. Means such a swivel pipe joint 13 can be used facilitate connection to a piping which delivers liquid or gas/air to the feeding pipes 11. A solenoid valve can then be used for regulating or controlling when air/gas or liquid is injected into the tubing 1.

FIG. 6 shows examples of different forms of one or more windings in the pump. The traditional winding in a pump is circular (A), but the winding can be formed as semi-circular (B) with a flat surface, semi-circular (C) with a flat surface and a ridge in the flat surface, hexagonal (D), octagonal (E), or Decagonal (F) to create uneven movement of the food items in the winding as it goes through the rocking movement. This increases the treatment movement of liquid or air against the food items. While most of the windings in a pump may be circular, windings where treatment of food items is facilitate may be semi-circular.

FIG. 7 shows an embodiment of the present invention, where the out-feed end of the spiral pump is formed to divide the items being pumped into a plurality of lanes. In this drawing the items being pumped are divided into four streams. This embodiment is particularly useful for the out-feeding of fish from the pump, where the fish is being set up for further processing such as a filleting machine. When fish are being transferred through a spiral pump, the fish have a tendency to align in the pump in a swimming position, i.e. head first. This means that when the fish exit the pump they can be received by an out-feeding portion as shown in FIG. 7 and directed into lanes on a further processing device such as a filleting machine. The drawing shows the out-feed end 3 of the pipe 2, where the opening of the out-feed end has been formed into four semi-channels 14 to spread the items as they are fed out of the pumping device.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention can be made while still falling within scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. An apparatus for treating food items in liquid media, the apparatus comprising:
a tubing with an in-feed end and an out-feed end, said tubing having three or more windings,
a horizontally rotating frame structure, wherein the tubing is wound around and/or into the frame structure,
a motor, and
control means, wherein the control means controls the motor and the motor rotates the horizontally rotating frame structure,
wherein the control means alters the speed of the rotation of the horizontally rotating frame structure at least once during every full cycle rotation.

2. The apparatus according to claim 1, wherein the control means generates a rocking motion in the tubing by rotating the horizontally rotating frame structure alternately backwards and forwards repeatedly for a predetermined period.

3. The apparatus according to claim 1, wherein the apparatus further comprises an in-feeding device for feeding food items into the in-feed end of the tubing, said in-feeding device further comprising:
an in-feed chamber, and
a closing means between the in-feed chamber and the in-feed end of the tubing.

4. The apparatus according to claim 1, further comprising an air-inlet in the first winding for creating under-pressure in the first winding of the pump.

5. The apparatus according to claim 1, further comprising a sensor for determining the position of the windings of the pump in each cycle of rotation.

6. The apparatus according to claim 1, wherein one or more of the windings in the pump is a semi-circular winding around the frame structure.

7. The apparatus according to claim 5, wherein the one or more semi-circular winding around the frame structure has pentagonal, hexagonal, heptagonal, octagonal, nonagonal, decagonal shape or where a circular winding has one or more ridges or indents in the circular shape.

8. The apparatus according to claim 1, wherein the apparatus further comprises one or more feeding pipes for introducing or extracting liquid or air from the tubing.

9. The apparatus according to claim 7, wherein the feeding pipe for introducing or extracting liquid or air from the tubing comprises a centrally arranged first feeding pipe in the frame structure and on or more second feeding pipes feeding into the tubing from first feeding pipe.

10. The apparatus according to claim 7, wherein the apparatus has two or more sets of first and second feeding pipes in the frame structure introducing or extracting liquid and air from the tubing or more than one type of air or liquid into the tubing

11. The apparatus according to claim 10, wherein the feeding pipe for introducing or extracting liquid or air/gas from the tubing comprises a centrally arranged first feeding pipe in the frame structure and on or more second feeding pipes feeding into the tubing from first feeding pipe.

12. The apparatus according to claim 1, wherein the apparatus has two or more sets of first and second feeding pipes in the frame structure introducing or extracting liquid and air from the tubing or more than one type of air or liquid into the tubing.

13. The apparatus according to claim 1, wherein the out-feed end of the pipe is formed into channels or semi-channels to distribute the food items laterally as the food items are fed out of the apparatus.

14. A method for treating food items, the method comprising:
a) providing a spiral pump, said spiral pump further comprising
a tubing with an in-feed end and an out-feed end, said tubing having three or more windings,
a horizontally rotating frame structure, wherein the tubing is wound around and/or into the frame structure,
a motor, and
control means,
b) feeding liquid through the in feed end into the first winding of the tubing wound around the frame structure,
c) feeding one or more food items into the first winding of the tubing wound around the frame structure through the in-feed end,
d) rotating the frame structure a full cycle around a horizontal central axis,
e) repeating steps b)-d) while there are food items to be feed into the first winding of the tubing wound around the frame structure, and
f) when the last items have undergone steps b)-e), the frame structure is rotated until the last food items have exited the out-feed end of the tubing.
wherein the motor rotates the horizontally rotating frame structure where the control means alters the speed of the rotation at least once during every full cycle rotation.

15. The method according to claim 14, wherein the liquid and the one or more food items are pre-blended before feeding into the first winding of the tubing wound around the frame structure thereby performing steps b) and c) simultaneously.

16. The method according to claim 14, wherein the control means generates a rocking motion in the tubing by rotating the horizontally rotating frame structure alternately backwards and forwards repeatedly for a predetermined period.

17. The method according to claim 14, wherein under-pressure is created in the first winding of the pump through an air-inlet in the first winding.

18. The method according to claim 14, wherein a sensor determines the position of the windings of the pump in the cycle of rotation.

19. The method according to claim 14, wherein a sensor detects when the first winding is approaching in-feeding position in it's cycle of rotation.

20. The method according to claim 14, wherein liquid or air can be fed into or extracted from one or more of the windings using one or more feeding pipes.

21. A system for treating food items in liquid media, the system comprising:
a) providing a spiral pump, said spiral pump further comprising
a tubing with an in-feed end and an out-feed end, said tubing having three or more windings,
a horizontally rotating frame structure, wherein the tubing is wound around and/or into the frame structure,
a motor, and
control means,
b) feeding liquid through the in feed end into the first winding of the tubing wound around the frame structure,
c) feeding one or more food items into the first winding of the tubing wound around the frame structure through the in-feed end,
d) rotating the frame structure a full cycle around a horizontal central axis,
e) repeating steps b)-d) while there are food items to be feed into the first winding of the tubing wound around the frame structure, and
f) when the last items have undergone steps b)-e), the frame structure is rotated until the last food items have exited the out-feed end of the tubing.
wherein the motor rotates the horizontally rotating frame structure where the control means alters the speed of the rotation at least once during every full cycle rotation.
